(19) United States
(12) Patent Application Publication
(10) Pub. No.: US 2013/0081312 A1
(43) Pub. Date: Apr. 4, 2013

(54) SPORTS FAN FOAM HAND DISPLAY

(71) Applicant: Bryan Mark McFadden, Williamston, MI (US)

(72) Inventor: Bryan Mark McFadden, Williamston, MI (US)

(21) Appl. No.: 13/623,080

(22) Filed: Sep. 19, 2012

Related U.S. Application Data
(60) Provisional application No. 61/542,236, filed on Oct. 2, 2011.

(51) Int. Cl. G09F 7/00

(52) U.S. Cl. 40/586

(57) ABSTRACT

A sports fan foam hand display combines a foam hand with a three-dimensional message to the sports team or player. The sports fan foam hand display can include a base member having cuts to form a fence shape. The letter “D” can be superimposed on the fence-shaped base member to create the message “D-fence” or defense. A slot can be provided to permit the user to wear the foam hand display on their hand. A region can be provided for the sport team's name and the entire foam hand display can be colored in various colors, such as the sport team's colors.

### CROSS-REFERENCE TO RELATED APPLICATION

This application claims the benefit of priority of U.S. provisional application No. 61/542,236, filed Oct. 2, 2011, the contents of which are herein incorporated by reference.

### BACKGROUND OF THE INVENTION

The present invention relates to sports fan accessories and, more particularly, to sports fan foam hand display.

When going to sporting events, many fans like to carry accessories to help cheer on their team. Many of these accessories can be signs, banners or the like.

Large foam hands have been used in many sport franchises, often colored in team colors, to cheer on their team or provide a defensive distraction. For example, many college basketball games have fans behind the opposing team's backboard that may wave foam hands with their school colors to distract a free throw shooter.

In some instances, more than one object is carried by a sports fan to deliver their message to their team. Carrying these objects can be difficult and cumbersome.

As can be seen, there is a need for a multi-function sports fan accessory that can provide a method to deliver a message to a team without having to carry multiple components.

### SUMMARY OF THE INVENTION

In one aspect of the present invention, a sports fan foam hand display comprises a base member formed into a first shape for delivering a portion of a message to a sports team; a raised indicia disposed on the base member, the raised indicia formed into a second shape for delivering another portion of a message to the sports team; and a slot provided along a lower edge of the base member, the slot operable to accept a user's hand therein.

In another aspect of the present invention, a sports fan foam hand display comprises a base member formed into a fence shape for delivering a portion of a message to a sports team; a raised indicia disposed on the base member, the raised indicia formed into a letter “D” shape for delivering another portion of a message to the sports team; a slot provided along a lower edge of the base member, the slot operable to accept a user's hand therein; and a team identification region displaying identifying information about the sports team.

These and other features, aspects and advantages of the present invention will become better understood with reference to the following drawings, description and claims.

### BRIEF DESCRIPTION OF THE DRAWINGS

FIG. 1 is a perspective view of a sports fan hand display according to an exemplary embodiment of the present invention;

FIG. 2 is a cross-sectional view taken along line 2-2 of FIG. 1; and

FIG. 3 is a perspective view of the sports fan hand display of FIG. 1, in use.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a sports fan foam hand display that combines a foam hand with a three-dimensional message to the sports team or player. The sports fan foam hand display can include a base member having cuts to form a fence shape. The letter “D” can be superimposed on the fence-shaped base member to create the message “D-fence” or defense. A slot can be provided to permit the user to wear the foam hand display on their hand. A region can be provided for the sport team's name and the entire foam hand display can be colored in various colors, such as the sport team's colors.

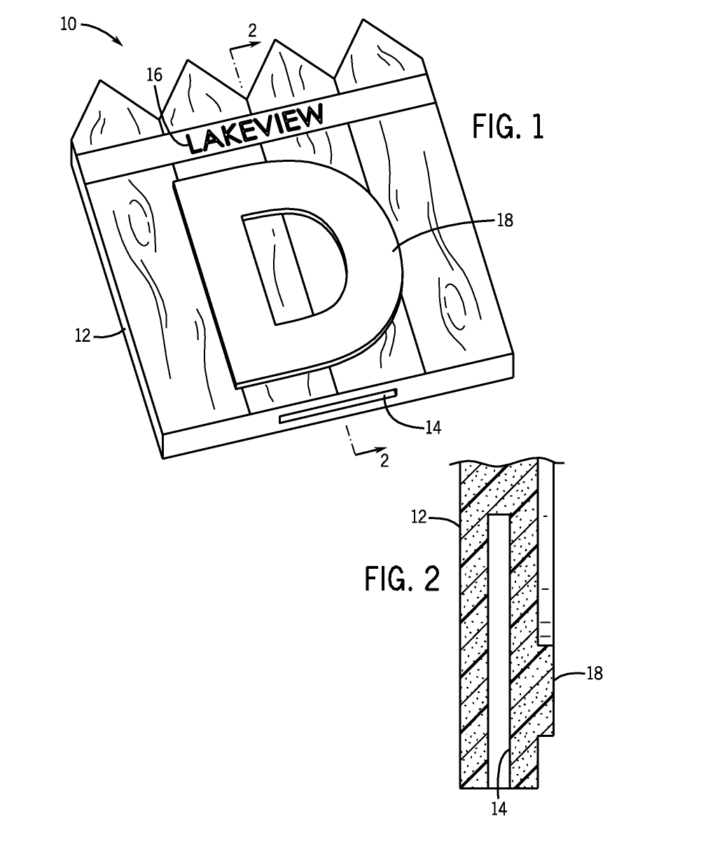

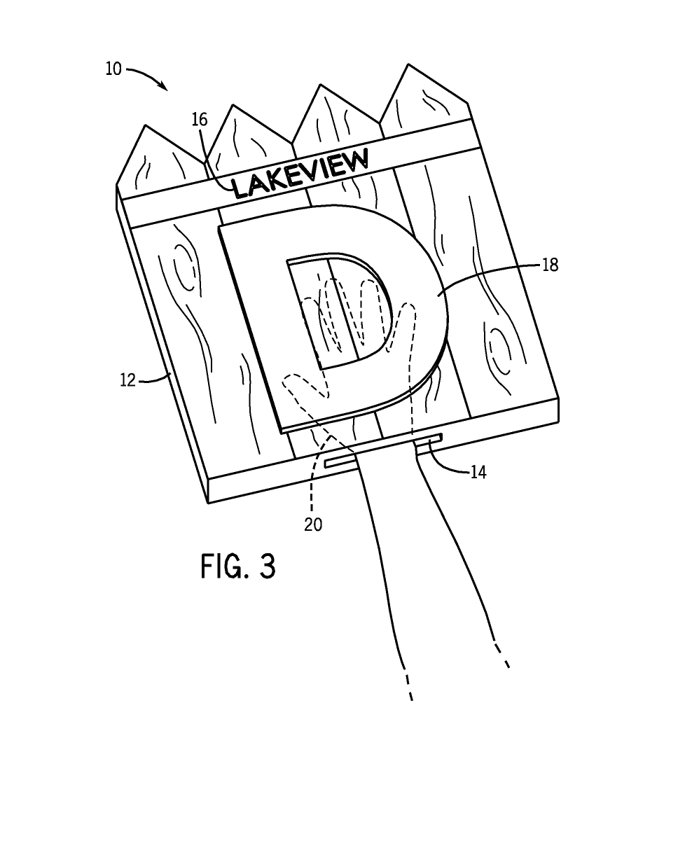

Referring now to FIGS. 1 through 3, a sports fan foam hand display 10 can include a base member 12 having a cut design to resemble a shape of a fence. The base member 12 can have a rail member 16 disposed similar to a fence rail along the fence-shaped base member 12. The rail member 16 can be designed to be imprinted with the sport team's city name, team name, mascot, or the like. A slot 14 can be provided along a bottom edge of the base member 12. The slot 14 can be adapted to accept a user's hand 20 therein, thereby supporting the base member 12 on the user's hand 20.

A raised indicia 18, such as the letter “D” can be disposed over the base member 12. The raised indicia 18, together with the base member 12, conveys a message to the sport team. For example, when the base member 12 is designed as a fence, and the raised indicia 18 is the letter “D”, the message “defense” can be relayed to the team in a fun, fan-friendly manner. Prior to the present invention, the user would have to carry the letter D and the fence separately, and hold each separately in each hand. With the sports fan foam hand display 10 of the present invention, the sports fan can simply wear their message on one hand, freeing up one hand and removing the need to grasp and hold the object.

It should be understood, of course, that the foregoing relates to exemplary embodiments of the invention and that modifications may be made without departing from the spirit and scope of the invention as set forth in the following claims.

What is claimed is:

1. A sports fan foam hand display comprising:
a base member formed into a first shape for delivering a portion of a message to a sports team;
a raised indicia disposed on the base member, the raised indicia formed into a second shape for delivering another portion of a message to the sports team; and
a slot provided along a lower edge of the base member, the slot operable to accept a user's hand therein.

2. The sports fan foam hand display of claim 1, wherein:
the first shape is a fence shape; and
the second shape is in a letter “D” shape.

3. The sports fan foam hand display of claim 1, further comprising a team identification region displaying identifying information about the sports team.

4. The sports fan foam display of claim 3, wherein the first shape is a fence shape and the team identification region is positioned along a fence rail region of the fence shape.

5. A sports fan foam hand display comprising:
a base member formed into a fence shape for delivering a portion of a message to a sports team;
a raised indicia disposed on the base member, the raised indicia formed into a letter “D” shape for delivering another portion of a message to the sports team;
a slot provided along a lower edge of the base member, the slot operable to accept a user's hand therein; and
a team identification region displaying identifying information about the sports team.

6. The sports fan foam display of claim 5, wherein the team identification region is positioned along a fence rail region of the fence shape.
